(19) United States
(12) Patent Application Publication
(10) Pub. No.: US 2023/0186819 A1
(43) Pub. Date: Jun. 15, 2023

(54) DIGITAL ANALOG MULTIPLICATION DRIVING METHOD FOR A DISPLAY DEVICE

(71) Applicant: HUAWEI TECHNOLOGIES CO., LTD., Shenzhen (CN)

(72) Inventors: Cheng-Chieh LIEN, Yokohama (JP); Akira SAKAIGAWA, Yokohama (JP)

(21) Appl. No.: 18/164,266

(22) Filed: Feb. 3, 2023

Related U.S. Application Data
(63) Continuation of application No. PCT/CN2020/107190, filed on Aug. 5, 2020.

(51) Int. Cl. G09G 3/20; G09G 3/32

(52) U.S. Cl. CPC G09G 3/2014; G09G 3/32; G09G 3/2081; G09G 3/2022; G09G 2320/0252; G09G 2360/16; G09G 2310/08

(57) ABSTRACT

The present disclosure provides operating methods and apparatuses of a display device. In an implementation, a method includes driving each pixel for each frame, wherein a plurality of pixels of the display device are disposed in an array of rows and columns, where a period of one frame comprises Nd time sections, one of Ba different voltage levels is applied to the pixel in each time section, Ba is greater than or equal to 3, the sum of the results of multiplying the length of each time section by the applied voltage level corresponds to a brightness, grey scale color, or luminance. One of suitable applications of the present invention is a micro-LED display.

### CROSS-REFERENCE TO RELATED APPLICATIONS

This application is a continuation of International Application No. PCT/CN2020/107190, filed on Aug. 5, 2020, the disclosure of which is hereby incorporated by reference in its entirety.

### TECHNICAL FIELD

The present invention generally relates to a method for driving a display device.

### BACKGROUND

The technology for light emitting diode (LED) displays has been increasingly developed in recent years. It has a large potential in the flat panel display market. The LED displays can be used in not only large panels such as TV and PC screens, but also tablets, smartphones, and wearable devices. Based on its high PPI (pixels per inch), it also has high potential to be used in AR/VR (augmented reality/virtual reality) application. In the future, micro-LED displays can replace LCDs and even also OLED displays.

In order to display a grey scale color, the micro-LED display is driven in the time domain by using pulse-width modulation (PWM), due to the characteristic differences between a liquid crystal display (LCD) and an organic light emitting diode (OLED) display. However, if the number of bits for specifying grey scale colors and the number of lines of a display device increase, the time for driving each pixel becomes short and is insufficient to complete the process.

### SUMMARY

An operating method of a display device is provided to increase available data driving time.

According to a first aspect, an operating method of a display device is provided, where the method includes driving each pixel for each frame, wherein a plurality of pixels of the display device are disposed in an array of rows and columns, a period of one frame comprises Nd time sections, one of Ba different voltage levels is applied to the pixel in each time section, Ba is greater than or equal to 3, and the sum of the results of multiplying the length of each time section by the applied voltage level corresponds to a specified brightness, grey scale color, or luminance.

In a possible implementation, Ba is 2\hat{ }Na, and Na×Nd is identical to the total bit depth of pixel data.

In a possible implementation, M^{th} shortest time section is Ba times as long as (M−1)^{th} time section, wherein M is an integer from 2 to Nd.

In a possible implementation, the display device is a micro-LED display.

According to a second aspect, a display device is provided, where the display device includes a plurality of pixels disposed in an array of rows and columns, where a period of one frame comprises Nd time sections, one of Ba different voltage levels is applied to the pixel in each time section, Ba is greater than or equal to 3, the sum of the results of multiplying the length of each time section by the applied voltage level corresponds to a specified brightness, grey scale color, or luminance, and a driver configured to drive each pixel for each frame.

In a possible implementation, Ba is 2\hat{ }Na, and Na×Nd is identical to the total bit depth of pixel data.

In a possible implementation, M^{th} shortest time section is Ba times as long as (M−1)^{th} time section, wherein M is an integer from 2 to Nd.

In a possible implementation, the display device is a micro-LED display.

### BRIEF DESCRIPTION OF DRAWINGS

To describe the technical solutions in the embodiments of the present invention or in the prior art more clearly, the following briefly introduces the accompanying drawings required for describing the embodiments or the prior art. The accompanying drawings in the following description show merely some embodiments of the present invention, and a person of ordinary skill in the art may still derive other drawings from these accompanying drawings without creative efforts.

FIG. 1 shows a simplified diagram of a PWM light control;

FIG. 2 shows an example of basic PWM waveforms for driving pixels;

FIG. 3 shows an example of waveforms for driving pixels;

FIG. 4 shows another example of waveforms for driving pixels;

FIG. 5 shows another example of waveforms for driving pixels for 16 grey scales;

FIG. 6 shows an example of waveforms for driving pixels with ideal binary sections;

FIG. 7 shows a waveform for data ‘2106’ for the pure digital driving;

FIG. 8 shows a waveform for data ‘2106’ for “Digital 6, Analog 2 Multiplication” driving;

FIG. 9 shows a luminance reference map for “Digital 6, Analog 2 Multiplication” driving;

FIG. 10 shows several examples of pixel waveforms for “Digital 6, Analog 2 Multiplication” driving;

FIG. 11 shows a waveform of data ‘63179’ for the pure digital driving;

FIG. 12 shows a luminance reference map for “Digital 9 and Analog 2 Multiplication” driving;

FIG. 13 shows several examples of pixel waveforms for “Digital 9, Analog 2 Multiplication” driving;

FIG. 14 shows a waveform for data ‘2106’ for the pure digital driving;

FIG. 15 shows a luminance reference map for “Digital 4, Analog 3 Multiplication” driving;

FIG. 16 shows several examples of pixel waveforms for “Digital 4, Analog 3 Multiplication” driving;

FIG. 17 shows a comparison of T_{DP} between different driving schemes for the number of lines from 800 to 1,700; and

FIG. 18 shows a comparison of T_{DP} between different driving schemes for the number of lines from 1,700 to 2,600.

### DESCRIPTION OF EMBODIMENTS

The following clearly and completely describes the technical solutions in the embodiments of the present invention with reference to the accompanying drawings in the embodiments of the present invention. The described embodiments are only some but not all of the embodiments of the present invention. All other embodiments obtained by a person of ordinary skill in the art based on the embodiments of the present invention without creative efforts shall fall within the protected scope of the present invention.

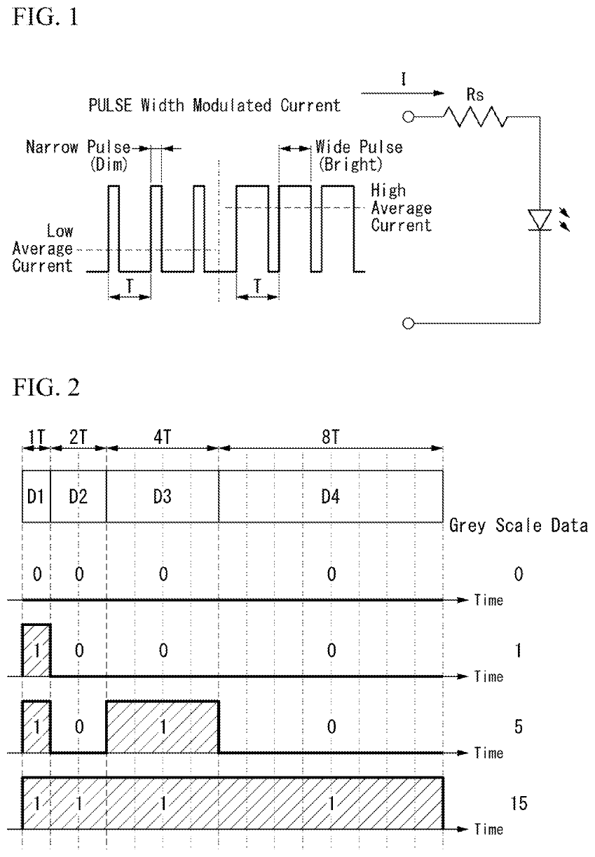

FIG. 1 shows a simplified diagram of a PWM light control. The PWM is widely used for driving a light emitting diode (LED). The LED is controlled according to the pulse width so that the LED has different accumulate energy and then has different luminance to achieve different grey scale color. The PWM is to modulate turn-on ratio, or called duty cycle in a period. The higher turn-on ratio be in the period, the higher accumulate energy the LED gets, and the higher accumulate energy the LED gets, the higher luminance the LED provides, and vice versa. For display applications, the PWM period is often set the same as a frame period.

A pixel may be a circuit for emitting light with a specified color and a specified brightness, grey scale, or luminance. A set of LEDs with red, blue, and green colors may be used for each pixel. However, the embodiments of the present invention focus on controlling brightness, grey scale, or luminance of each LED.

FIG. 2 shows an example of basic PWM waveforms by a Binary Address Group (BAG) scheme. The BAG scheme is based on digital driving or PWM scheme. It only has a two-state signal (1 or 0) for driving pixels on a display device. Original grey scale data is converted into n-bit binary data, and then a PWM period is divided into n time sections. The length of each time section is not the same but the time length relationship from small to large is 1T, 2T, 4T, 8T, . . . . The length of the last time section is 2\hat{ }(n−1)*T. The order of time sections can be changed in any order. The only restriction is the total length of time sections should be (2\hat{ }n−1)*T. In an example shown in FIG. 1, n=4 and time sections are arranged from small to large. The total energy or luminance of an LED is in proportion to the sum of the areas under the waveform (grey areas marked “1”). It can be seen that the LED can be driven only by changing states n times (n is 4 in FIG. 1) in one PWM period (for example, changing states at the beginning of 1T, 2T, 3T, and 4T), then we can get 2\hat{ }n steps (16 steps in FIG. 1) of different energy or luminance can be obtained. The 2\hat{ }n steps can be used for displaying grey scales and the bit depth of pixel data is n.

Since each time section above corresponds to one bit data, this time section is also referred to as “a data section” below, and in particular, since in most examples below, the data is binary data, this time section is also referred to as “a binary section”, and the length of this time section is referred to as “a binary length”.

In general, pixels are disposed in an array of p rows (p scan lines) and q columns (q data lines) on a display device. The array may correspond to all or a part of the display device. The pixel may include a thin film transistor (TFT) or a silicon substrate. All pixels need to be driven in one frame time. The value of q has no relation to the driving time sequences, and the driving time sequences are repeated for q columns, and thus q can be any number, and it can be just assumed to be one for easy to understand.

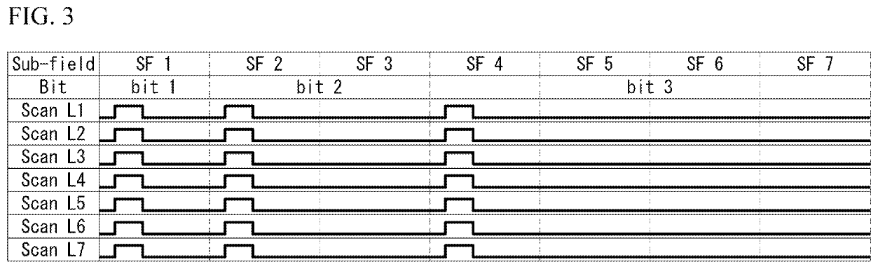

FIG. 3 shows an example of waveforms for driving 7 scan lines (7 pixels), and each pixel is driven with 3 bits (hereinafter, each waveform for driving a pixel is also referred to as “a driving sequence”). At the initial part of SF1 (sub-field 1), SF2, and SF4, a high signal means being turned ON, and a low signal means being turned OFF, namely, state changes are performed. First, each line is driven with bit1 (least significant bit (LSB)). After a time period 1T, the same line is driven with bit 2. After a time period 2T, the same line is driven with bit 3 (most significant bit (MSB)). After a time period 4T, this time frame ends.

In this example, the number of bits for specifying a brightness, grey scale color, or illuminance is n=3, and the sum of the weights of bit1, bit2, and bit3 is 2\hat{ }n−1 is 7, so one frame time is divided into 7 sub-fields (SFs). However, no processing is performed in SF3, SF5, SF6, and SF7 for driving pixels, namely, a duration of time is not used efficiently. In this method, if the number of lines is p, p*(2\hat{ }n−1) SFs are needed for driving data.

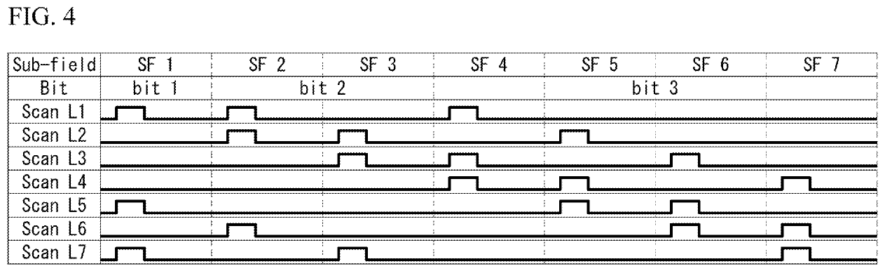

FIG. 4 shows another example of driving pixels in an efficient way. The pixel on the Scan L1 line is driven in SF1 for bit 1, SF2 for bit 2, and SF4 for bit 3. For the Scan L2 line, one SF is shifted compared to the Scan L1 line, and the pixel is driven in SF2 for bit 1, SF3 for bit 2, and SF5 for bit 3. For the Scan L3 line, one SF is shifted compared to the Scan L2 line, and the pixel is driven in SF3 for bit 1, SF4 for bit 2, and SF6 for bit 3. The same operations are repeated for the Scan L4 line to the Scan L7 line.

This kind of driving scheme is called “Binary Address Group (BAG)” driving. The characteristic of the BAG is that the number of small periods for driving pixel data is p*n, which is much smaller than p*(2\hat{ }n−1) when n becomes larger such as 10, 12, or 14. Only 7*3=21 data driving periods are needed in the example of FIG. 4, while 7*7=49 data driving periods are needed in the example of FIG. 3, because the SFs with a turn-on signal cannot be simultaneously processed.

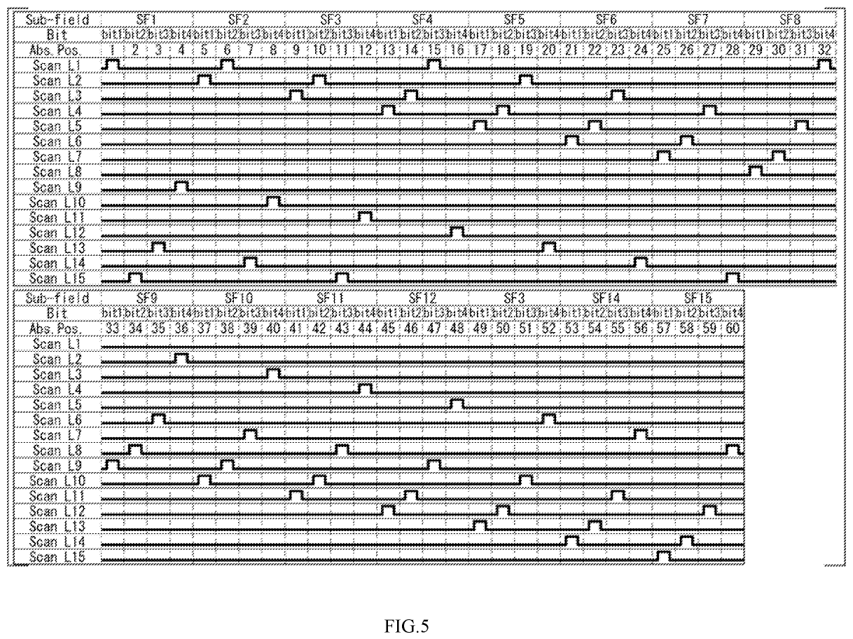

More efficient driving waveforms in one frame can be constructed based on the BAG scheme. It is assumed that the number of rows p is 15, and bit depth n is 4. FIG. 5 shows another example of waveforms for driving pixels for 16 grey scales or 16 linear steps from 0 to 15 for all pixels in 15 lines.

In FIG. 5, one frame time T_{FRAME} is divided into 15 sub-field times T_{SF} because n=4 and 2\hat{ }n−1 is 15. Therefore, T_{FRAME} equals 15*T_{SF} in this example. Next, each SF is divided into 4 periods for each bit for a state change. This period is called “available data driving time” represented by T_{DP}, and T_{DP} is a unit of time for constructing a driving sequence. Therefore, T_{SF} equals 4*T_{DP} in this example. In the BAG scheme, the binary length corresponding to each bit is mainly produced by combining SFs. If we set the starting time of the Scan L1 line to be located at SF1, and the order of the binary length is 1, 2, 4, and 8, bits 1, 2, 3, and 4 for state changes are located in SF1, SF2, SF4, and SF8, respectively.

As mentioned above, there are 15 T_{SF} in one T_{FRAME} and 4 T_{DP} in one T_{SF}. Therefore, there are 60 T_{DP} in one frame (or in one T_{FRAME}). 60 T_{DP} are numbered from 1 to 60 and each position is called an absolute position (AbsPos) in one frame. In FIG. 5, for Scan L1 line, bit 1 is at AbsPos 1, bit 2 is at AbsPos 6, bit 3 is at AbsPos 15, and bit 4 is at AbsPos 32. For Scan L2 line, the starting point is located at first T_{DP} of SF2 which is at AbsPos 5 in this frame. Bits 1, 2, 3 and 4 of Scan L2 line are located at AubPos 5, 10, 19 and 36. For Scan L3 line to Scan L15 line, bits 1, 2, 3, and 4 are located similarly. The periods for holding states for bits 1, 2, 3, and 4 are expected to be 1×, 2×, 4×, and 8× (multiples of 1, 2, 4, and 8), respectively. However, the actual periods are 5*T_{DP}, 9*T_{DP}, 17*T_{DP}, and 29*T_{DP}, as shown in TABLE 1 below. It should be noted that for example, for Scan L1 line, 29*T_{DP} comes from the time length between bit 4 of SF8 of the current frame and bit 1 of SF1 of the next frame. The series 5, 9, 17, and 29 do not comply with binary relationships 1×, 2×, 4×, and 8×. There exists errors in this solution. Therefore, serial binary sections are non-ideal.

TABLE 1
Binary Section Length by Basic BAG Scheme
(Bit Depth = 4, Line = 15)

| Time Length | T_{SF} + T_{DP} | Value | Multi |
|---|---|---|---|
| Binary sec 1 = | T_{SF}* 1 + T_{DP}* 1 | = 5 | 1 |
| Binary sec 2 = | T_{SF}* 2 + T_{DP}* 1 | = 9 | 1.8 |
| Binary sec 3 = | T_{SF}* 4 + T_{DP}* 1 | = 17 | 3.4 |
| Binary sec 4 = | T_{SF}* 8 + T_{DP}* − 3 | = 29 | 5.8 |
| Sum = | T_{SF}* 15 + T_{DP}* 0 | = 60 | 12 |

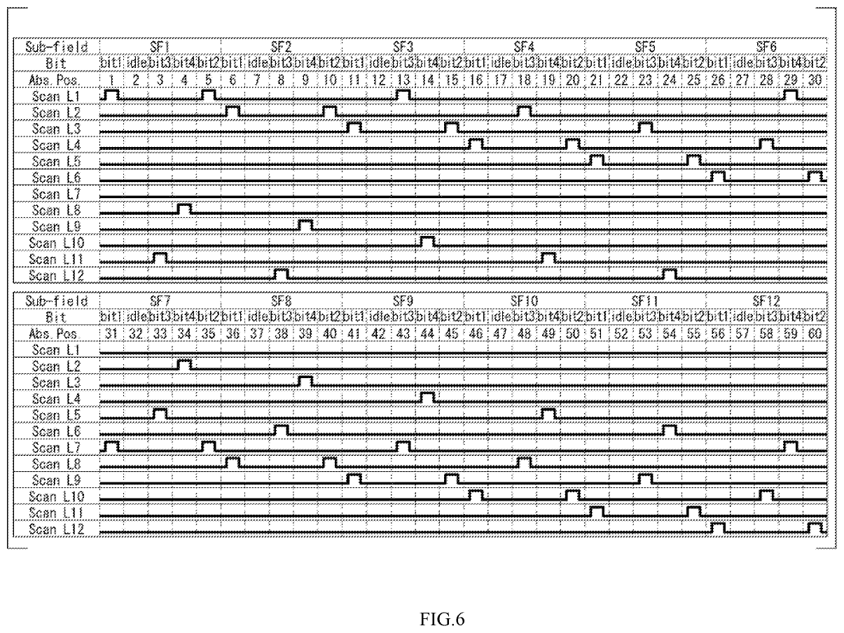

FIG. 6 shows an example of waveforms for driving pixels with ideal binary sections. In order to solve the above problem of non-ideal binary sections, the driving waveform is modified. In this example, bit depth n is 4, and the number of lines is 12. First, SFs are divided into 5 periods but not 4 periods. It means T_{SF} equals 5*T_{DP}. The number of periods in one SF is defined as the number of cycles (CY). So, the CY is set to be n+1, which is bit depth+1. Second, a grey scale unit (GSU) is determined. GSU corresponds to the number of T_{DP} corresponding to the minimum binary section. In this case, in order to construct a sequence of ideal binary sections, the total length of binary sections will be a multiple of 15, because 1+2+4+8=15. The number of lines is 12, and GSU is selected to be 4. Since the time length of GSU is 4*T_{DP}, the total length of binary sections is 4*15 which equals 60. Therefore, T_{FRAME}=60*T_{DP}. Since CY=5, each T_{SF} equals 5*T_{DP}, there are 12 SFs in one frame, and thereby each SF can be a starting point of one line. Therefore, this is a solution with ideal binary sections for the case where n=4, and the number of lines=12.

Besides, there is one difference between the basic BAG scheme (FIG. 5) and the BAG scheme with ideal binary sections (FIG. 6). We can observe that all T_{DP} in one SF are used for driving a pixel in FIG. 5. But there is one T_{DP} which is not used for driving a pixel in FIG. 6. It is the second T_{DP} position in every SF. The T_{DP} without driving a pixel is an “idle” period in each SF. It is an unavoidable sacrifice in timing when trying to use the BAG scheme with ideal binary sections.

The T_{DP} position in one SF is defined with a relative position (RelPos) so as to be easily described below. For each AbsPos, the relationship between AbsPos and RelPos is

AbsPos=(k−1)×CY+RelPos (1)

where AbsPos belongs to the k^{th} SF.

TABLE 2 shows line numbers to be turned ON for each sub-field and each RelPos in the waveforms in FIG. 6. It is easy to check when the waveform sequence becomes long and lines increase significantly. TABLE 3 shows binary section length by the BAG Scheme with ideal binary sections (bit depth=4, the number of lines=12).

TABLE 2
Line numbers to be turned ON by BAG Scheme with Ideal Binary
Sections (Bit Depth = 4, Line = 12)

| | RelPos | | | | |
|---|---|---|---|---|---|
| | 1 | 2 | 3 | 4 | 5 |
| Bit | Bit 1 | Idle | Bit 3 | Bit 4 | Bit 2 |
| SF 1 | 1 | — | 11 | 8 | 1 |
| SF 2 | 2 | — | 12 | 9 | 2 |
| SF 3 | 3 | — | 1 | 10 | 3 |
| SF 4 | 4 | — | 2 | 11 | 4 |
| SF 5 | 5 | — | 3 | 12 | 5 |
| SF 6 | 6 | — | 4 | 1 | 6 |
| SF 7 | 7 | — | 5 | 2 | 7 |
| SF 8 | 8 | — | 6 | 3 | 8 |
| SF 9 | 9 | — | 7 | 4 | 9 |
| SF 10 | 10 | — | 8 | 5 | 10 |
| SF 11 | 11 | — | 9 | 6 | 11 |
| SF 12 | 12 | — | 10 | 7 | 12 |

TABLE 3
Binary Section Length by BAG Scheme with Ideal Binary
Sections (Bit Depth = 4, Line = 12)

| Time Length | T_{SF} + T_{DP} | Value | Multi |
|---|---|---|---|
| Binary sec 1 = | T_{SF}* 1 + T_{DP}* − 1 | = 4 | 1 |
| Binary sec 2 = | T_{SF}* 2 + T_{DP}* − 2 | = 8 | 2 |
| Binary sec 3 = | T_{SF}* 4 + T_{DP}* − 4 | = 16 | 4 |
| Binary sec 4 = | T_{SF}* 8 + T_{DP}* − 8 | = 32 | 8 |
| Sum = | T_{SF}* 15 + T_{DP}* − 15 | = 60 | 15 |

The waveforms for driving pixels in FIG. 6 show ideal binary sections, in which brightness relationship is correct for a display device with p rows. However, the main problem is that the available data driving time T_{DP} is short and it is hard to complete the whole driving action. Also, in some cases, the ideal binary sections cannot use a duration of time in a most optimized way.

For further discussion, this BAG scheme is summarized with mathematical equations:

SF×CY=GSU×DSW_sum (2)

DSW_sum means “data section weight sum” that is the sum of the weight of all data sections (binary sections). For example, if n=4, the sum of the weight of all binary sections is 1+2+4+8=15. All BAG solutions need to satisfy equation (2) and the following equation (3):

T_{FRAME}=T_{DP}×SF×CY (3)

T_{DP} is the time period for driving pixels of each line, because T_{FRAME} is fixed once the frame rate is determined. CY depends on bit depth n. If T_{DP} needs to be increased for driving, the number of SFs needs to be decreased. However, as can be seen from the example in FIG. 6, the number of SFs cannot be lower than the number of lines, because each line should be driven once in one frame. Therefore, the principle to find a BAG solution is to find the minimum GSU that satisfies equation (2) and following equation (4):

SF≥the number of lines (4)

Using a large number of bits, it is assumed that bit depth n=12, and the number of lines=630. Then, CY should be n+1 which is 13 and DSW_sum is 1+2+4+ . . . +1024+2048=4095. According to equation (4), the minimum GSU should be 2 and the number of SFs becomes 2×4095/13=630, which satisfies SF≥the number of lines.

T_{DP} can be derived from equations (2) and (3) as follows:

$${T}_{DP} = \frac{{T}_{SF}}{CY} = \frac{{T}_{FRAME}}{CY \times SF\_number} = \frac{{T}_{FRAME}}{GSU \times DSW\_sum} \qquad ( 5 )$$

According to equation (5) with CY=13 and SF_number=630, T_{DP} is calculated as (T_{FRAME}/630/13)=(T_{FRAME}/8190). Assuming that frame rate=60 Hz, T_{FRAME}= 1/60 s. Then, T_{DP} is 2.035 us. In some worse cases, it might be insufficient to drive pixels. Thus, it needs to find ways to provide a longer T_{DP} and correct grey scales for each pixel.

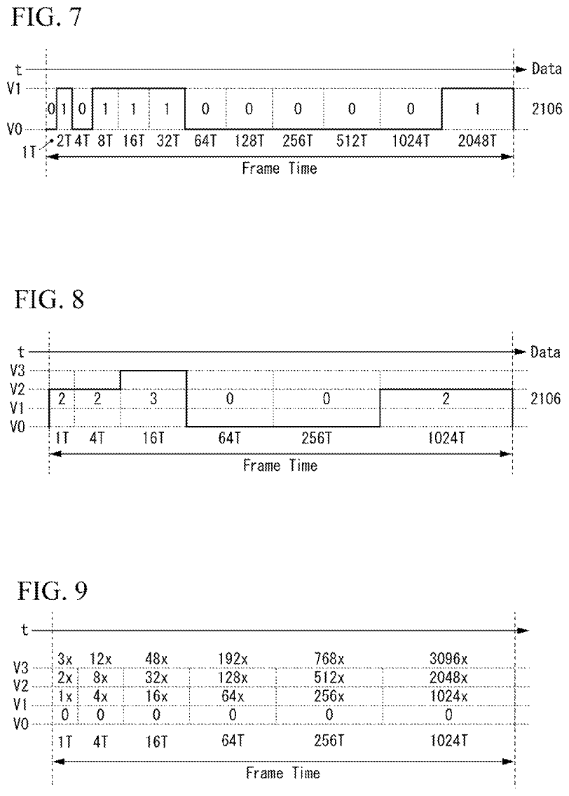

In an example where a bit depth n=12, it is assumed that data for a certain pixel in a certain frame in the binary system is ‘1000_0011_1010’. In the BAG scheme, the waveform for the data for this pixel is as shown in FIG. 7.

This kind of basic BAG driving waveform is also called a pure digital driving. The feature of the pure digital driving is that data for driving a pixel is only ‘1’ and ‘0’ which are V_{CC} and V_{SS}, or V₁ and V₀ in the voltage domain. This kind of pure digital driving can drive each pixel in a correct grey scale, but as mentioned before, the available data driving time T_{DP} may be not enough, and then cause a wrong display color. It needs to find ways to extend T_{DP} and still keep each pixel in a correct grey scale at the same time.

The following describes a “Digital Analog Multiplication” driving sequence. This idea is a kind of digital and analog hybrid driving scheme. The total bit depth of pixel data is decomposed into two parts, digital bits and analog bits, and the product of the number of digital bits and the number of analog bits is the number of total bits.

In an example where the number of total bits n=12, in the conventional BAG scheme, the total grey scales have 2\hat{ }12 steps. All the 12 bits are digital bits. According to this idea, one solution is that the analog bits are set to 2 bits, and then the digital bits becomes 12/2 which is 6 bits. The product of 2 and 6 is 12. Therefore, this scheme is called a “Digital Analog Multiplication” driving scheme.

An embodiment of the present invention is described with reference to FIG. 8 to FIG. 10. FIG. 8 shows an example of a Digital Analog Multiplication driving sequence for a pixel in one frame with total bit depth n=12. This driving sequence for each pixel in one frame has only 6 time periods or 6 time sections, which is different from the pure digital driving which has 12 time periods or 12 time sections. The number of time periods is equal to the number of digital bits. Thus, the number of digital bits for a driving waveform in FIG. 8 is 6.

Each time section in FIG. 8 has 4 possible driving voltages, namely, 4 different steps in the voltage domain. The driving voltage of each time section is determined by the analog bits. In this case of 4 possible driving voltages, since 4 is 2\hat{ }2, the analog bits in this example of FIG. 8 is 2. The number of digital bits is 6, the number of analog bits is 2, and the number of total bits is 6×2=12.

It is assumed that data with total bit depth n=12 of a certain pixel in a certain frame is ‘1000_0011_1010’ that is the same as data in FIG. 7. In order to use the Digital Analog Multiplication driving, the pixel data needs to be converted from the binary system to another carry system.

First, the analog bits are set to 2 and the digital bits are set to 6 because 12/2=6. This means that there are 2\hat{ }2=4 possible driving voltages in each time section, and there are 6 time sections in total for each pixel in one frame. The time length relationship between time sections is 4 times. That is to say, if the time length of the LSB time section is 1T, then the time length of time sections are 1T, 4T, 16T, 64T, 256T, and 1024T.

Second, data is converted from the binary system to the 4th carry system, for example, binary data ‘1000_0011_1010’ becomes 4th carry data ‘20_0322’. The resulting waveform of the pixel is shown in FIG. 8. The relationship between V₃, V₂, V₁, and V₀ is output emission energy ratio or output luminance ratio that is driven by V₃, V₂, V₁, and V₀ and is 3×, 2×, 1×, and 0 (multiples of 3, 2, 1, and 0).

FIG. 9 shows luminance levels corresponding to voltage steps in each time section.

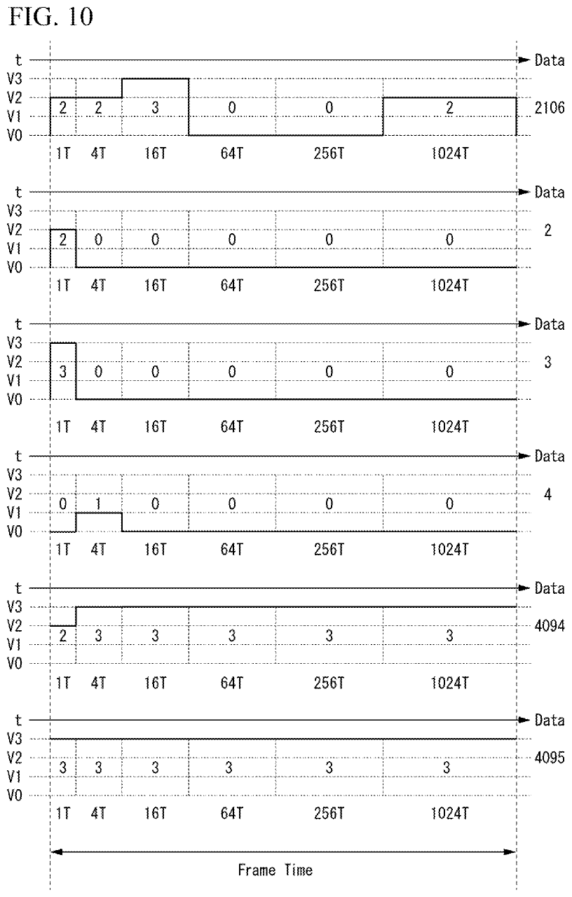

FIG. 10 shows several examples of pixel waveforms for different grey scales. The first waveform for data ‘2106’ is the same as that in FIG. 8, and it can be seen how this scheme works for 12 bit data: 2, 3, 4, 4094, and 4095, namely, how the waveforms change for data from 2 to 4, and how the waveforms change for data from 4094 to 4095. This scheme works correctly when the energy ratio or luminance ratio for driving satisfies that V₃ is 3 times as high as V₁, and V₂ is twice as high as V₁.

The following describes three embodiments of the present invention, and comparison with the pure digital driving waveform.

The first embodiment of the present invention refers to the same example as described above with reference to FIG. 8 to FIG. 10, and is compared with the pure digital driving waveform shown in FIG. 7. In this embodiment, the total bit depth n of the pixel data is 12.

FIG. 7 shows a pure digital driving waveform example of a pixel in one frame with total bit depth n=12. It has 12 time periods or 12 time sections in one frame The number of digital bits here is 12. The data “2106” in the decimal system is ‘1000_0011_1010’ in the binary system. So, there are 12 time sections in one frame.

(1) In the time domain, the time length of the first time section is 1T long, the second time section is 2T long, the third time section is 4T long, . . . , and the last time section is 2,048T long.
(2) In the voltage domain, the voltage level of the first time section is high or V₁, the second time section is low or V₀, the third time section is low or V₀, the fourth time section is low or V₀, . . . , and the last time section is low or V₀.
(3) Checking the available data driving time T_{DP}, there are 1T+2T+4T+ . . . +2,048T=4,095T in total in one frame, and therefore, T_{DP} here is (T_{FRAME}/4,095).

This waveform in FIG. 7 can drive pixel data ‘2106’.

FIG. 9 shows a luminance level reference of the Digital Analog Multiplication scheme where the number of analog bits is 2 and the number of digital bits is 6. The time length of each time section is 4 times as long as the previous time section. There are 4 voltage levels V₃, V₂, V₁, and V₀. The emission device turns OFF when driving at V₀. The luminance of driving at V₂ is as twice as that of driving at V₁, and the luminance of driving at V₃ is 3 times as high as that of driving at V₁. And then a full map of luminance level reference in one frame is as shown in FIG. 10.

FIG. 10 shows the pixel waveforms of the Digital Analog Multiplication scheme where the number of analog bits is 2 and the number of digital bits is 6. For example, data “2106” in the decimal system is ‘1000_0011_1010’ in the binary system. The data needs to be converted into a 4^{th} carry system, in which the data is ‘20_0322’, and then the waveform is as shown at the top of FIG. 10. The other waveforms are also shown in FIG. 10.

(1) In the time domain, the time length of the first time section is 1T long, the second time section is 4T long, the third time section is 16T long, . . . , and the last time section is 1,024T long.
(2) In the voltage domain, the voltage level of the first time section is V₂, the second time section is V₀, the third time section is V₀, the fourth time section is V₃, . . . , and the last time section is V₂.
(3) Checking the available data driving time T_{DP}, there are 1T+4T+16T++1,024T=4,095T in total in one frame, and therefore, T_{DP} here is (T_{FRAME}/1,365). In this embodiment, T_{DP} is 3 times as long as that of the pure digital driving scheme.

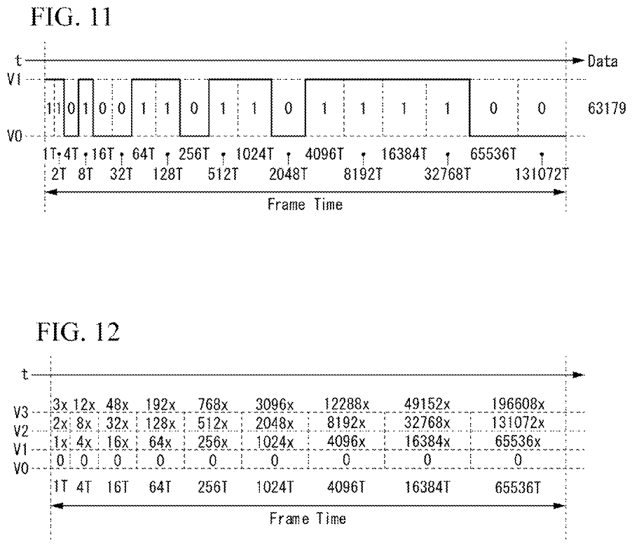

Next, the second embodiment of the present invention is described with reference to FIG. 11 to FIG. 13. In this embodiment, the total bit depth n of the pixel data is 18.

FIG. 11 shows a pure digital driving waveform example of a pixel in one frame with total bit depth n=18. It has 18 time periods or 18 time sections in one frame. The number of digital bits here is 18. The data ‘63179’ in the decimal system is ‘0011_1101_1011_0010_11’ in the binary system. So, there are 18 time sections in one frame.

(1) In the time domain, the time length of the first time section is 1T long, the second time section is 2T long, the third time section is 4T long, and the last time section is 131,072T long.
(2) In the voltage domain, the voltage level of the first time section is low or V₀, the second time section is low or V₀, the third time section is high or V₁, the fourth tome section is high or V₁, . . . , and the last time section is high or V₁.
(3) Checking the available data driving time T_{DP}, there are 1T+2T+4T+ . . . +131,072T=262,143T in total in one frame, and therefore, T_{DP} here is (T_{FRAME}/262,143).

Then this waveform in FIG. 11 can display pixel data ‘63179’.

FIG. 12 shows a luminance level reference of the Digital Analog Multiplication scheme wherein the number of analog bits is 2 and the number of digital bits is 9. The time length of each time section is 4 times as long as that of the previous time section. There are 4 voltage levels V₃, V₂, V₁, and V₀. The emission device turns OFF when driving at V₀. The luminance of driving at V₂ is as twice as that of driving at V₁, the luminance of driving at V₃ is 3 times as high as that of driving at V₁. And then a full map of luminance level reference in one frame is as shown in FIG. 12.

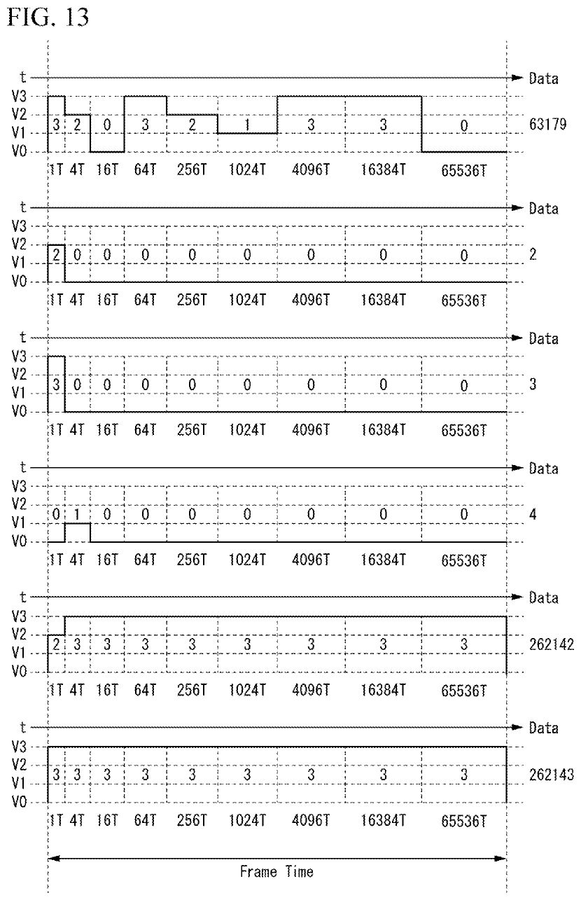

FIG. 13 shows the data waveform of the Digital Analog Multiplication scheme where the number of analog bits is 2 and the number of digital bits is 9. The data ‘63179’ in the decimal system is ‘0011_1101_1011_0010_11’ in the binary system. The data need to be converted into a 4^{th} carry system in which the data is ‘0331_2302_3’, and then waveform is as shown at the top of FIG. 13. The other waveforms are also shown in FIG. 13.

(1) In the time domain, the time length of the first time section is 1T long, the second the section is 4T long, the third time section is 16T long, and the last time section is 65,536T long.
(2) In the voltage domain, the voltage level of the first time section is V₀, the second time section is V₃, the third time section is V₃, the fourth time section is V₁, . . . , and the last time section is V₃.
(3) Checking the available data driving time T_{DP}, there are 1T+4T+16T+ . . . +65,536T=87,381T in total in one frame, and therefore, T_{DP} here is (T_{FRAME}/87,381). In this embodiment, T_{DP} is 3 times as long as that of the pure digital driving scheme.

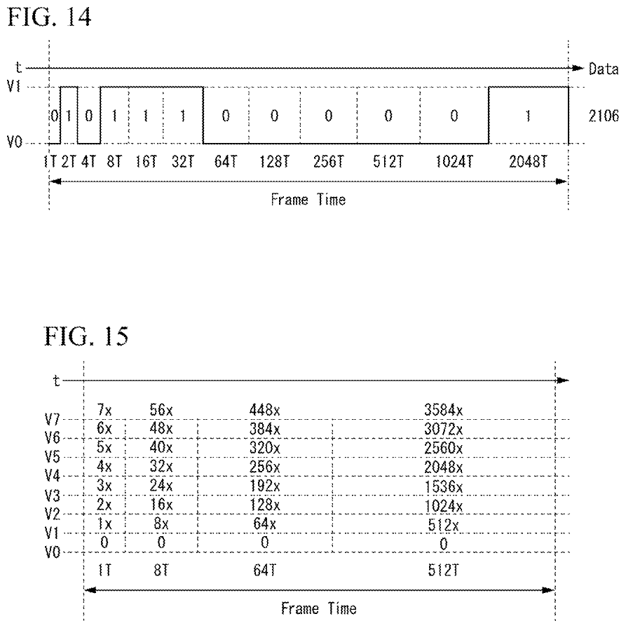

Next, the third embodiment of the present invention is described with reference to FIG. 14 to FIG. 16. In this embodiment, the total bit depth n of the pixel data is 12.

FIG. 14 shows a pure digital driving waveform example of a pixel in one frame with total bit depth n=12. It has 12 time periods or 12 time sections in one frame. The number of digital bits here is 12. The data ‘2106’ in the decimal system is ‘1000_0011_1010’ in the binary system. So, there are 12 time sections in one frame.

(1) In the time domain, the time length of the first time section is 1T long, the second time section is 2T long, the third time section is 4T long, . . . , and the last time section is 2,048T long.
(2) In the voltage domain, the voltage level of the first time section is high or V1, the second time section is low or V0, the third time section is low or V0, the fourth time section is low or V0, . . . , and the last time section is low or V0.
(3) Checking the available data driving time T_{DP}, there are 1T+2T+4T++2,048T=4,095T in total in one frame, and therefore, T_{DP} here is (T_{FRAME}/4,095).

This waveform in FIG. 14 can display pixel data ‘2106’.

FIG. 15 shows a luminance level reference of the Digital Analog Multiplication scheme where the number of analog bits is 3 and the number of digital bits is 4. The time length of each time section is 8 times as long as that of the previous time section. There are 8 voltage levels V₇, V₆, V₅, V₄, V₃, V₂, V₁, and V₀. The emission device turns OFF when driving at V₀. The luminance of driving at V₂ is as twice as that of driving at V₁, the luminance of driving at V₃ is 3 times as high as that of driving at V₁, and the luminance of driving at V₇ is 7 times as high as that of driving at V₁. And then a full map of luminance level reference in one frame is as shown in FIG. 15.

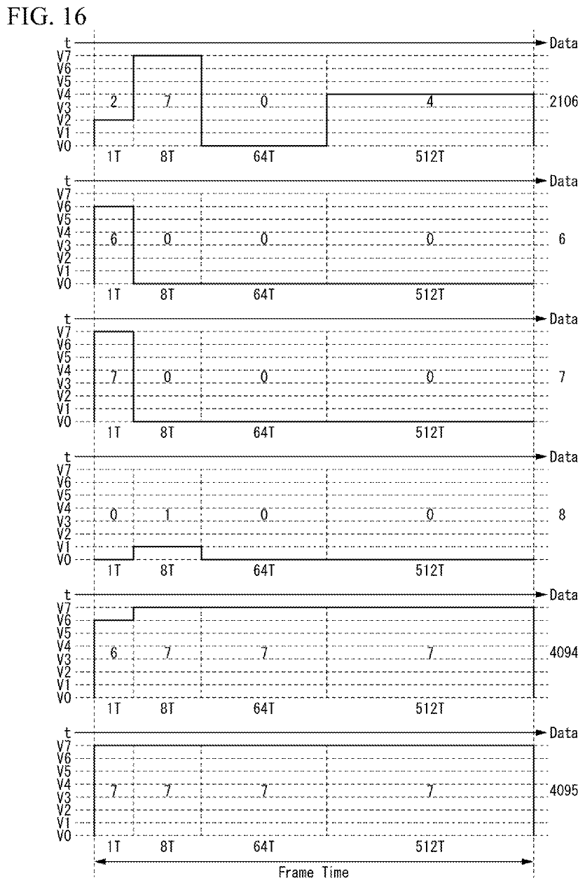

FIG. 16 shows the data waveform of the Digital Analog Multiplication scheme where the number of analog bits is 3 and the number of digital bits is 4. The data ‘2106’ in the decimal system is ‘1000_0011_1010’ in the binary system. The data need to be converted into an 8^{th} carry system, in which the data is ‘4072’, and then the waveform is as shown at the top of FIG. 16. The other waveforms are also shown in FIG. 16.

(1) In the time domain, the time length of the first time section is 1T long, the second time section is 8T long, the third time section is 64T long, . . . , and the last time section is 512T long.
(2) In the voltage domain, the voltage level of the first time section is V₄, the second time section is V0, the third time section is V₇, and the last time section is V₂.
(3) Checking the available data driving time T_{DP}, there are 1T+8T+64T+512T=585T in total in one frame, and therefore, T_{DP} here is (T_{FRAME}/585). In this embodiment, T_{DP} is 7 times as long as that of the pure digital driving scheme.

In another embodiment, the order of time sections may be changed in any order.

In another embodiment, regarding the second time section to the last time section, each time section may be m times as long as the previous time section, the voltage levels may have m steps, and m is an integer greater than or equal to 3. In addition, the order of time sections may be changed in any order.

As application scenarios, the embodiments of the present invention can be mainly used for driving micro-LED display devices. Not only micro-LED displays but also any other display devices can be driven by PWM controls such as a display device with a bi-stable emission device. From a product point of view, the embodiments of the present invention can be used in any kind of display in consumer electronics, automotive, and industrial products.

For micro-LED displays having an array of pixels in which row*column is p*q, the Digital Analog Multiplication driving of the embodiments of the present application provides a driving sequence which is composed by both digital bits and analog bits. The product of the number of digital bits and the number of analog bits is equal to the total bit depth of the pixel data. The digital bits determine the number of time sections in one frame. The number of time sections is always larger or equal to the number of digital bits. The number of analog bits has a relationship with analog voltage steps.

According to the embodiments of the present invention, all of p*q pixels in an array of a display device can display correct grey scale colors and the available data driving time is arranged in an optimized way.

The effects and advantages by the embodiments of the present invention are as follows:

The most significant improvement of the embodiments of the present invention is that the available data driving time T_{DP} is increased. The larger T_{DP} makes it easier to drive each pixel with correct data or voltage. So, color performance of the micro-LED is improved.

Comparing with the BAG scheme which can be recognized as a pure digital driving scheme, according to equations (2) and (3) above, the T_{DP} equation of the BAG scheme is:

$${T}_{DP} = \frac{{T}_{SF}}{CY} = \frac{{T}_{FRAME}}{CY \times SF\_number} = \frac{{T}_{FRAME}}{GSU \times DSW\_sum} \qquad ( 5 )$$

Equation (5) can also be used to calculate T_{DP} for the Digital Analog Multiplication driving scheme.

In the case where the total data bit depth is 12 and the number of lines is 960, for the BAG scheme driving sequence with pure digital bits, all the 12 bits are digital bits. Then, the series of data section weights is 1, 2, 4, 8, . . . , 2048 and DSW_sum is 4095. CY is 13 and GSU is chosen to be 4 to get a minimum SF number so that 4095*4/13=1,260 according to CY×SF_number=GSU×DSW_sum that is devived from equation (5). 1,260 is the minimum SF number greater than or equal to 960 in the BAG scheme with the pure digital bit solutions. Thus, for frame rate is 60 Hz, T_{DP} is 1/60/13/1260=1.018 us according to T_{DP}=T_{FRAME}/(CY×SF_number) in equation (5), as shown in the left column in TABLE 4 below.

In the case where the total data bit depth is 12 and the number of lines is 960, for the driving sequence with the Digital Analog Multiplication scheme, the number of digital bits is chosen to be 6 and the number of analog bits is chosen to be 2. Then, the series of data section weights are 1, 4, 16, 64, . . . , 1024 and DSW_sum is 1365. CY is 7 and GSU is chosen to be 5 so that 1365*5/7=975. 975 is the minimum SF number greater than or equal to 960 in the driving sequence with solution that the number of digital bits is 6 and the number of analog bits is 2 of the Digital Analog Multiplication scheme. Thus, for a frame rate of 60 Hz, T_{DP} is 1/60/7/975=2.442 us. This is 2.4 times as long as that of the pure digital bit scheme, as shown in the middle column in TABLE 4 below.

In the case where the total data bit depth is 12 and the number of lines is 960, for the driving sequence with the Digital Analog Multiplication scheme, the number of digital bits is chosen to be 4 and the number of analog bits is chosen to be 3. Then, the series of data section weights are 1, 8, 64, 512 and DSW_sum is 585. CY is 5 and GSU is chosen to be 9 so that 585*9/5=1,053. 1,053 is the minimum SF number greater than or equal to 960 in the driving sequence with the solution that the number of digital bits is 4 and the number of analog bits is 3 of the Digital Analog Multiplication scheme. Thus, for a frame rate of 60 Hz, T_{DP} is 1/60/5/1053=3.166 us. This is 3.1 times as long as that of the pure digital bit scheme, as shown in the right column in TABLE 4 below.

TABLE 4 is a summary of comparison between the above cases including the BAG scheme and the Digital Analog Multiplication driving scheme. The CY can be downscaled and then get a larger available data driving time in the driving sequence. For different display resolutions, there are a different number of lines. The improvement percentage of T_{DP} is different case by case.

TABLE 4
T_{DP} Improvement by the Digital Analog Multiplication scheme (Total Bit Depth = 12)

| | | Driving Scheme | | |
|---|---|---|---|---|
| | | Pure Digital | Digital × Analog | Digital × Analog |
| Type | | Prior Art, BAG | Embodiment | Embodiment |
| Total Data Bit Depth | | 12 | 12 | 12 |
| Digital Bits | | 12 | 6 | 4 |
| Analog Bits | | — | 2 | 3 |
| Number of Lines | — | 960 | 960 | 960 |
| Number of Cycles | CY | 13 | 7 | 5 |
| Number of Sub-fields | SF_Num | 1260 | 975 | 1053 |
| Grey Scale Unit | GSU | 4 | 5 | 9 |
| Data Section Weight Sum | DSW_Sum | 4,095 | 1,365 | 585 |
| Frame Rate | (Hz) | 60 | 60 | 60 |
| T_{SF} | (us) | 13.228 | 17.094 | 15.8278 |
| T_{DP} | (us) | 1.018 | 2.442 | 3.166 |
| ΔT_{DP} % | — | 0% | 140% | 211% |

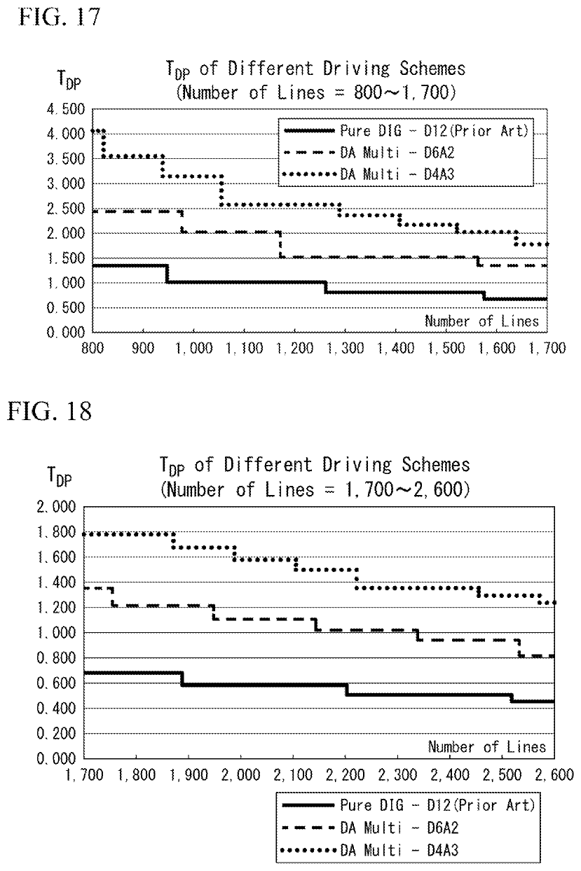

FIG. 17 and FIG. 18 show the summary of different displays with the number of lines from 800 to 2,600. The x-axis denotes the number of lines of displays and y-axis denotes available data driving time T_{DP}. We can observe the solutions of the Digital Analog Multiplication driving scheme can provide longer T_{DP} for driving each pixel on a display device. For the number of lines, the difference in the vertical direction in FIG. 17 and FIG. 18 indicates the T_{DP} improvement by the Digital Analog Multiplication scheme from the conventional driving scheme. The timing improvement of the embodiments of the present invention is about from 80% to 16%, depending on the number of lines of displays.

The embodiments of the present invention can be applied to not only micro-LED displays, but also display devices with other materials using PWM control, digital driving, or analog and digital combined driving.

What is disclosed above is merely exemplary embodiments of the present invention, and certainly is not intended to limit the protection scope of the present invention. A person of ordinary skill in the art may understand that all or some of processes that implement the foregoing embodiments and equivalent modifications made in accordance with the claims of the present invention shall fall within the scope of the present invention.

What is claimed is:

1. An operating method of a display device, comprising:
driving each of a plurality of pixels of a display device for each of a plurality of frames, wherein the plurality of pixels are disposed in an array of rows and columns, a period of each of the plurality of frames comprises Nd time sections, one of Ba voltage levels is applied to a pixel in each of the Nd time sections, wherein Ba is greater than or equal to 3, and a sum of results of multiplying a length of each of the Nd time sections by a respective one of the Ba voltage levels applied corresponds to one of a brightness, a grey scale color, or a luminance.

2. The operating method according to claim 1, wherein Ba equals 2^{Na}, and Na×Nd is equals a total bit depth of pixel data.

3. The operating method according to claim 1, wherein a M^{th} time section of the Nd time sections has a length that is Ba times of a length of a (M−1)^{th} time section, wherein M is an integer from 2 to Nd.

4. The operating method according to claim 1, wherein the display device is a micro-LED display.

5. A display device, comprising:
a plurality of pixels disposed in an array of rows and columns, wherein a period of a frame comprises Nd time sections, one of Ba voltage levels is applied to a pixel in each of the Nd time sections, wherein Ba is greater than or equal to 3, a sum of results of multiplying a length of each of the Nd time section by a respective one of the Ba voltage levels corresponds to one of a brightness, a grey scale color, or a luminance; and
a driver that drives each pixel for the frame.

6. The display device according to claim 5, wherein Ba equals 2=^{Na}, and Na×Nd equals a total bit depth of pixel data.

7. The display device according to claim 5, wherein a M^{th} time section of the Nd time sections has a length that is Ba times of a length of a (M−1)^{th} time section, wherein M is an integer from 2 to Nd.

8. The display device according to claim 5, wherein the display device is a micro-LED display.
